(19) United States
(12) Patent Application Publication
(10) Pub. No.: US 2026/0065659 A1
(43) Pub. Date: Mar. 5, 2026

(54) METHOD FOR PROCESSING SENSOR DATA, OBJECT DETECTION NETWORK, AND METHOD FOR ADAPTING AN OBJECT DETECTION NETWORK

(71) Applicant: Robert Bosch GmbH, Stuttgart (DE)

(72) Inventors: Kilian Rambach, Stuttgart (DE); Oliver Kern, Renningen (DE); Ruediger Jordan, Stuttgart (DE)

(21) Appl. No.: 19/289,402

(22) Filed: Aug. 4, 2025

(30) Foreign Application Priority Data
Aug. 28, 2024 (DE) 10 2024 208 162.0

(51) Int. Cl. G06V 10/82; G06V 10/774; G06V 10/80

(52) U.S. Cl. CPC G06V 10/82; G06V 10/774; G06V 10/80

(57) ABSTRACT

A method for processing sensor data, specifying at least one environmental object, from multiple environmental sensors. The method includes providing first sensor data from a first environmental sensor, providing second sensor data from a second environmental sensor, providing a first adapter unit and a second adapter unit, providing an object detection model with at least one trained artificial neural network, inputting the first sensor data into the first adapter unit and computing first interface data that fulfill a specified interface data specification as output of the first adapter unit, inputting the second sensor data into the second adapter unit and computing second interface data that fulfill the interface data specification as output of the second adapter unit, inputting the first and second interface data as input data into the object detection model and computing at least one object parameter of the at least one environmental object as output.

### CROSS REFERENCE

The present application claims the benefit under 35 U.S.C. § 119 of Germany Patent Application No. DE 10 2024 208 162.0 filed on Aug. 28, 2024, which is expressly incorporated herein by reference in its entirety.

### FIELD

The present invention relates to a method for processing sensor data. Furthermore, the present invention relates to an object detection network and to a method for adapting an object detection network.

### BACKGROUND INFORMATION

The advanced driver assistance systems (ADAS) and autonomous driving (AD) functions now used in vehicles require precise detection and representation of the vehicle environment of the vehicle. For example, environmental sensors, such as cameras, LIDAR sensors, and radar sensors, are used for this purpose. Radar sensors play a special role here since they not only work reliably in poor visibility conditions, such as fog or darkness, but also provide detailed information on the vehicle environment.

A common application area for radar sensors is object recognition. For this purpose, the radar sensors generate point clouds consisting of individual reflections. Each reflection is described by polar coordinates such as distance and azimuth angle, as well as other features such as signal strength, radar cross-section (RCS), and elevation angle. By means of object detection models for detecting environmental objects in the vehicle environment, which are now largely based on deep learning, relevant objects such as cars, trucks, or pedestrians are identified from these point clouds. The object detection models ascertain, for example, the position, orientation (pose), class, and possibly further properties of the environmental objects and can represent the environmental objects in the form of oriented bounding boxes (OBB).

The output of the object detection models depends on the input data from the environmental sensors, which in turn can differ due to the specific properties of the environmental sensors. The object detection models are therefore adapted to and trained on the individual environmental sensors. If an environmental sensor is replaced with a new environmental sensor of a different type, the object detection model must be retrained with the new sensor data. This means that the training data from the new environmental sensor must be acquired and processed before the training process of the object detection model is repeated.

### SUMMARY

According to the present invention, a method for processing sensor data, specifying at least one environmental object, from multiple environmental sensors, is provided. According to an example embodiment of the present invention, the method includes: providing at least first sensor data from a first environmental sensor; providing at least second sensor data from a second environmental sensor; providing at least a first adapter unit and a second adapter unit; providing at least one object detection model with at least one trained artificial neural network; inputting the first sensor data into the first adapter unit and computing first interface data that fulfill a specified interface data specification as output of the first adapter unit; inputting the second sensor data into the second adapter unit and computing second interface data that fulfill the interface data specification as output of the second adapter unit; inputting the first and second interface data as input data into the object detection model and computing at least one object parameter of the at least one environmental object as output.

This allows the object detection model to perform the computation regardless of the type of the environmental sensors providing the input data. The computation of the object detection model can be decoupled from the type of the environmental sensors and from the specific data format of the sensor data. Adapting the object detection network to a new sensor data format or a new environmental sensor can be carried out faster and more easily.

The environmental sensors may be radar sensors, LIDAR sensors, cameras, ultrasonic sensors, and/or acceleration sensors. The environmental sensors may be arranged on a vehicle, a device, or a mobile robot.

The environmental object may be a living being, a building, a plant, an item, a device, or a vehicle.

The sensor data from an environmental sensor may be available as a point cloud, frequency spectrum, or time signal.

The object detection model may be configured for object recognition, object classification, semantic segmentation, and/or free space recognition. The object detection model may be configured for one task, such as object recognition, or for multiple tasks, such as object recognition and object classification.

The object detection model may comprise multiple layers in the neural network, including at least one input layer, multiple intermediate layers, and at least one output layer.

According to an example embodiment of the present invention, the object detection model may be a convolutional neural network (CNN). The CNN uses convolutional layers, in particular two-dimensional convolutional layers, with convolutions for filtering and extracting features from the interface data as input data, in particular in order to recognize structures and patterns in the input data. The CNN comprises at least one convolutional layer, one pooling layer and/or one dense output layer. The pooling layer can be a mean pooling layer or a max pooling layer. The pooling layer can apply global pooling. The convolutional layer can be used for feature extraction, the pooling layer for reducing the spatial size of the features and the dense output layer for classification. If storage requirements are particularly high, the CNN can manage only with one convolutional layer and one pooling layer, which makes storing the convolutional features unnecessary.

The interface data may be used as input data in a sensor fusion model. The sensor fusion model may be part of the object detection model or be upstream thereof.

The interface data specification may be a specification for a data structure, a data format, a data type, and/or a data quality of the interface data. By adhering to the interface data specification, uniform interface data can be available regardless of the structure of the input data.

According to an example embodiment of the present invention, the interface data may be mapped into an embedded space by the particular adapter unit. The interface data specification may specify the dimensions of the embedded space, pattern specifications, structure specifications, and/or limit values in the embedded space. The interface data specification may form a standard with regard to the interface data, through which standard the interface data are available in a uniform data format, in a uniform data type, and/or in a uniform data structure.

According to an example embodiment of the present invention, the adapter units and the object detection model may form an object detection network that computes at least one object parameter of the at least one environmental object depending on the sensor data from the environmental sensors as input data.

Training is the iterative process in which the neural network learns from training data to improve predictive accuracy. First, the input data together with the associated correct outputs (annotations) are specified to the neural network as a target specification. The neural network processes these data through its layers and outputs a prediction. This prediction is then compared with the actual annotations and the error or loss is calculated. This loss indicates how far the prediction of the neural network is from the actual answer. In order to minimize this error, the parameters of the neural network, in particular the weights, are adjusted. This is done, for example, by the gradient descent method, in which the gradient of the loss with respect to the weights is calculated. The weights are then changed in the direction that reduces the loss. This process is repeated over many iterations, with the neural network continuously adjusting its weights to reduce the error and to make more accurate predictions. The goal of training is to optimize the parameters such that the neural network performs accurate computations even with new, unseen input data.

In a preferred embodiment of the present invention, it is advantageous if the first and/or second adapter unit comprises a trained artificial neural network. The training of the object detection model may be carried out together with training of the first and second adapter units. The object detection model may also be trained independently of training of the first and second adapter units.

The model parameters of the object detection model may initially be trained together with the model parameters of the adapter units. Multiple sensor data from corresponding environmental sensors may be available as training data. The model parameters of the adapter units may be trained as follows. On the one hand, it is possible to train only the model parameters of the adapter unit of which the associated environmental sensor forms the currently used training data in the individual run. All the training data can form a random sequence of the sensor data from the environmental sensors. On the other hand, only a plurality of sensor data from a single environmental sensor may first form the training data and, after multiple runs and training of the model parameters of the adapter unit associated therewith, the next adapter unit may be trained with the corresponding sensor data as training data.

The learning rate during the training of the adapter units may be the same or different from each other. The learning rate during the training of the object detection model may be the same as or different from a learning rate during the training of at least one of the adapter units or during the training of all adapter units.

If fewer training data are available for one environmental sensor and thus for the associated adapter unit than for another environmental sensor and thus for the associated adapter unit, repeated use of the fewer training data can be implemented during the training of the object detection network in order to allow each adapter unit during training to receive the same amount of training data to be trained. Alternatively, a different weighting may be applied when calculating the loss function, if the amount of training data used during training differs between the adapter units.

If the number of parameters of model parameters to be trained differs between the adapter units, the repeated application of training data to the adapter unit with the higher number of model parameters or a different weighting in the calculation of the loss function may be used.

If a trained object detection model already exists, the first layers of this object detection model may be used as a basis for an adapter unit to be newly trained. This allows the weights of these layers to be initialized, which accelerates the further training of the adapter unit. This procedure can be applied to one or more adapter units.

The adapter units may also be pre-trained using unsupervised learning. The result of this unsupervised learning may serve as a starting point (initialization of the weights) for the subsequent supervised learning. This not only accelerates supervised learning but also reduces the need for labeled data. An example of unsupervised learning is to train the adapter unit with an auxiliary task. Such an auxiliary task may, for example, consist of learning how the sensor data, which are assumed to be available as points, must be rotated as input data in 90-degree steps in order to match a specified point pattern as interface data specification.

The first and/or second adapter unit may additionally or alternatively comprise a deterministic algorithm.

A preferred example embodiment of the present invention is advantageous in which the number of parameters of the trained model parameters of the first and/or second adapter unit is smaller than a number of parameters of the trained model parameters of the object detection model. This allows the object detection model to be used quickly and easily with new sensor data and/or a new environmental sensor that replaces an existing one or is added, without having to adapt the object detection model itself or without having to make complex adjustments.

In an advantageous example embodiment of the present invention, the number of parameters of the particular adapter unit depends on the data modality of the corresponding sensor data. The data modality specifies a data structure, a data type, and/or a data format of the sensor data. The larger the data structure, the data type, and/or the data format of the sensor data as input data of the particular adapter unit is, the larger the number of parameters of this adapter unit may be. This allows the amount of information in the sensor data to be processed reliably.

In a specific example embodiment of the present invention, it is advantageous if at least a third adapter unit computes third sensor data from a third environmental sensor to form third interface data that fulfill the interface data specification and form further input data for the object detection model. This can increase the amount and/or quality of the input data for the object detection. Further adapter units may also compute further sensor data from further environmental sensors to form further interface data that fulfill the interface data specification and form additional further input data for the object detection model.

In a preferred example embodiment of the present invention, the third or at least one further environmental sensor is associated with a sensor modality that differs from a sensor modality of the first and/or second environmental sensor and/or that the third sensor data or further sensor data are associated with a data modality that differs from a data modality of the first and/or second sensor data. Due to the uniform interface data specification, the input data for the object detection model can be uniform and independent of the sensor modality and/or the data modality. The sensor modality specifies a sensor class of the environmental sensor. For example, a radar sensor is associated with a different sensor modality than a LIDAR sensor or a camera.

In a preferred example embodiment of the present invention, the computation of the first and second interface data can be performed in parallel on the basis of the corresponding sensor data. The computed first and second interface data can be processed sequentially, fused, or in parallel by the object detection model.

According to the present invention, an object detection network is also provided.

According to the present invention, a method for adapting an object detection network is also proposed. The adaptation method may also include adapting to at least one further environmental sensor analogously to the third environmental sensor.

In an advantageous embodiment of the present invention, the model parameters of the object detection model remain unchanged during the training of the third adapter unit or are trained at most at a learning rate that is lower than a learning rate during the training of the third adapter unit. This can reduce the effort required to adapt the object detection network to the additional third environmental sensor.

According to the present invention, a computer program is also provided, which has machine-readable instructions executable on at least one computer, the execution of said instructions causing the described processing method of the present invention or the described adaptation method of the present invention to run.

According to the present invention, a storage unit is also provided, which is machine-readable and accessible by at least one computer and in which the above-described computer program is stored.

Further advantages and advantageous embodiments of the present invention can be found in the description of the figures and in the figures.

### BRIEF DESCRIPTION OF THE DRAWINGS

The present invention is described in detail below with reference to the figures.

FIG. 1 shows a method for processing sensor data in a specific embodiment of the present invention.

FIG. 2 shows a method for adapting an object detection network in a specific embodiment of the present invention.

### DETAILED DESCRIPTION OF EXAMPLE EMBODIMENTS

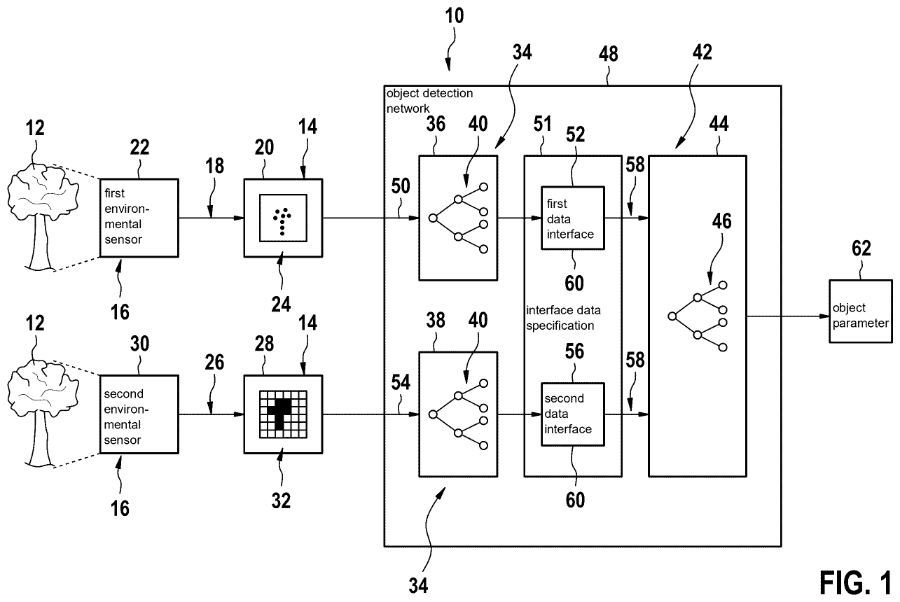

FIG. 1 shows a method for processing sensor data in a specific embodiment of the present invention. The method for processing 10 sensor data 14, specifying at least one environmental object 12, from multiple environmental sensors 16 comprises providing 18 at least first sensor data 20 from a first environmental sensor 22. The first environmental sensor 22 may be a radar sensor and the first sensor data 20 may be associated with a first data modality 24, for example as a point cloud. Furthermore, at least second sensor data 28 from a second environmental sensor 30 are provided 26. The second environmental sensor 30 may be a camera and the second sensor data 28 may be associated with a second data modality 32, for example as camera images having pixels, that differs from the first data modality 24.

Subsequently, at least a first adapter unit 36 and a second adapter unit 38 are provided 34. The first and second adapter units 36, 38 preferably each have a trained artificial neural network 40 with multiple layers.

Furthermore, at least one object detection model 44 with at least one trained artificial neural network 46 with multiple layers is provided 42. The number of parameters of the trained model parameters of the first or second adapter unit 36, 38 is in particular smaller than a number of parameters of the trained model parameters of the object detection model 44. The number of parameters of the particular adapter unit 36, 38 depends, for example, on the data modality of the corresponding sensor data 14. This means that the larger the data structure and/or the data format of the sensor data 14 is, the larger is the number of parameters of the associated adapter unit 36, 38 also. Together with the first and second adapter units 36, 38, the object detection model 44 forms an object detection network 48.

Furthermore, the first sensor data 20 are input 50 into the first adapter unit 36, and first interface data 52 that fulfill a specified interface data specification 51 are computed by the first adapter unit 36. The interface data specification 51 is a specification for the interface data with respect to the data structure, the data type, and/or the data format of the sensor data 14. The interface data specification 51 may form a standard with regard to the interface data, through which standard the interface data are available in a uniform data format, in a uniform data type, and/or in a uniform data structure. In this case, the interface data specification 51 is specified in a fixed manner.

Furthermore, in parallel or after the computation of the first interface data 52, the second sensor data 28 are input 54 into the second adapter unit 38, and second interface data 56 that fulfill the interface data specification 51 are computed by the second adapter unit 38.

Subsequently, the first and second interface data 52, 56 are input 58 as input data 60 into the object detection model 44, and at least one object parameter 62 of the at least one environmental object 12 is computed as output of the object detection model 44. The object parameter 62 may be an object type and the object detection model 44 may be used for object classification.

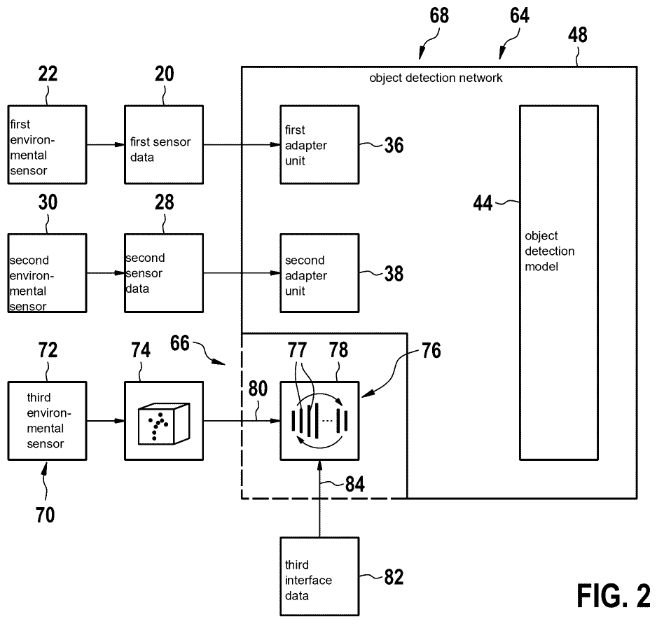

FIG. 2 shows a method for adapting an object detection network in a specific embodiment of the present invention. The method for adapting 64 an object detection network 48, here an expansion 66 of the object detection network 48 by the processing of third sensor data from a third environmental sensor, comprises providing 68 the object detection network 48 for detecting environmental objects depending on the first and second sensor data 20, 28 from the first and second environmental sensors 22, 30. The object detection network 48 is configured to carry out the processing method described in FIG. 1 and comprises the first adapter unit 36, the second adapter unit 38, and the object detection model 44.

Furthermore, a third environmental sensor 72, which provides third sensor data 74, is provided 70. The third sensor data 74 have a data modality that differs from a data modality of the first and second sensor data 20, 28. For example, the third environmental sensor 72 is a LIDAR sensor and the third sensor data 74 are available as a point cloud but differ in a data structure, for example in the dimensions spanning the point cloud, from the dimensions in which the point cloud of the first sensor data 20 is spanned, and are therefore associated with a different data modality.

Subsequently, a third adapter unit 78 having a neural network with multiple layers 77 is trained 76 with the third sensor data 74 as input data 80 and with third interface data 82 that fulfill the interface data specification, as annotated data as a target specification 84 during the training 76. As soon as the third adapter unit 78 has been trained, the object detection network 48 is expanded by the third adapter unit 78 and the possibility of processing the third sensor data 74.

What is claimed is:

1. A method for processing sensor data, specifying at least one environmental object, from multiple environmental sensors, the method comprising the following steps:
providing at least first sensor data from a first environmental sensor;
providing at least second sensor data from a second environmental sensor;
providing at least a first adapter unit and a second adapter unit;
providing at least one object detection model with at least one trained artificial neural network;
inputting the first sensor data into the first adapter unit and computing first interface data that fulfill a specified interface data specification as output of the first adapter unit;
inputting the second sensor data into the second adapter unit and computing second interface data that fulfill the interface data specification as output of the second adapter unit; and
inputting the first and second interface data as input data into the object detection model and computing at least one object parameter of the at least one environmental object as output.

2. The method for processing method sensor data according to claim 1, wherein the first and/or second adapter unit includes a trained artificial neural network.

3. The method for processing method sensor data according to claim 2, wherein a number of parameters of the trained model parameters of the first and/or second adapter unit is smaller than a number of parameters of the trained model parameters of the object detection model.

4. The method for processing method sensor data according to claim 3, wherein the number of parameters of the first and/or second adapter unit depends on a data modality of the first and/or second sensor data.

5. The method for processing method sensor data according to claim 1, wherein at least a third adapter unit processes third sensor data from a third environmental sensor to form third interface data that fulfill the interface data specification and form further input data for the object detection model.

6. The method for processing method sensor data according to claim 5, wherein: (i) the third environmental sensor is associated with a sensor modality that differs from a sensor modality of the first and/or second environmental sensor, and/or (ii) the third sensor data are associated with a data modality that differs from a data modality of the first and/or second sensor data.

7. The method for processing method sensor data according to claim 1, wherein the computation of the first and second interface data can be performed in parallel based on the first and second sensor data, respectively.

8. An object detection network for detecting environmental objects depending on sensor data from environmental sensors, the object detection network comprising:
at least the first adapter unit and second adapter unit; and
an object detection model including at least one trained artificial neural network;
wherein the object detection interface is configured to:
provide at least first sensor data from a first environmental sensor,
provide at least second sensor data from a second environmental sensor,
input the first sensor data into the first adapter unit and compute first interface data that fulfill a specified interface data specification as output of the first adapter unit,
input the second sensor data into the second adapter unit and compute second interface data that fulfill the interface data specification as output of the second adapter unit, and
input the first and second interface data as input data into the object detection model and computing at least one object parameter of the at least one environmental object as output.

9. A method for adapting an object detection network to at least a third environmental sensor, the method comprising the following steps:
providing the object detection network, the object detection network configured to detect environmental objects depending on sensor data from environmental sensors, the object detection network including:
at least the first adapter unit and second adapter unit, and
an object detection model including at least one trained artificial neural network,
wherein the object detection interface is configured to:
provide at least first sensor data from a first environmental sensor,
provide at least second sensor data from a second environmental sensor,
input the first sensor data into the first adapter unit and compute first interface data that fulfill a specified interface data specification as output of the first adapter unit,
input the second sensor data into the second adapter unit and compute second interface data that fulfill the interface data specification as output of the second adapter unit, and
input the first and second interface data as input data into the object detection model and computing at least one object parameter of the at least one environmental object as output,
providing at least a third environmental sensor providing third sensor data having a data modality that differs from a data modality of the first and second sensor data;
training a third adapter unit with at least the third sensor data as input data and with third interface data that fulfill the interface data specification as a target specification.

10. The method for adapting the object detection network according to claim 9, wherein model parameters of the object detection model remain unchanged during the training of the third adapter unit or are trained at most at a learning rate that is lower than a learning rate during the training of the third adapter unit.
